(19) United States
(12) Patent Application Publication
(10) Pub. No.: US 2022/0142047 A1
(43) Pub. Date: May 12, 2022

(54) LAWN MOWER EXTENSION

(71) Applicants: Michael Gotcher, Austin, TX (US); Beverly Gotcher, Austin, TX (US)

(72) Inventors: Michael Gotcher, Austin, TX (US); Beverly Gotcher, Austin, TX (US)

(21) Appl. No.: 17/094,773

(22) Filed: Nov. 10, 2020

(51) Int. Cl. A01D 34/685; A01D 34/81; A01D 34/78

(52) U.S. Cl. CPC A01D 34/685; A01D 2101/00; A01D 34/78; A01D 34/81

(57) ABSTRACT

A lawnmower trimming and edging extension is attached to a lawnmower. The lawnmower has a motor, a deck, and a push handle. The lawnmower extension includes a trimmer motor having a shaft and a self-feeding string trimmer cutter coupled to the shaft. The trimmer motor coupled to the deck and oriented the self-feeding trimmer cutter to cut an area about the deck. The trimming extension controls electrically connects the trimmer motor to an electrical power source and the trimming extension controls. An outside protective plate is coupled to an inside protective plate by a trimmer-edger hinge and to the deck. The trimmer-edger hinge pivots the inside protective plate between a horizontal position and a vertical position. The trimmer motor is coupled to the inside protective plate such that is self-feeding trimmer cutter is oriented as the inside protective plate when it pivots between the horizontal position and the vertical position.

### TECHNICAL FIELD

This application relates in general to an article of manufacture for providing a lawn care tool, and more specifically, to an article of manufacture for a lawnmower trimming and edging extension.

### BACKGROUND

Cutting grass with a residential walk-behind, riding, or standing lawnmower is a common activity for many individuals. The lawnmower does a good job of cutting the grass across a lawn to a particular height set by the height of the cutting blades above the ground. The spinning cutting blades pose a risk of injury to the operator of the lawnmower if the individual gets too close to the cutting blades while the motor is operating. As such, the cutting blades have been encased under a lawnmower deck that protrudes downward to create a barrier between the cutting area around the cutting blades and the outside area around the lawnmower.

This barrier that the lawnmower deck creates does an adequate job of keeping the cutting blades away from the user; unfortunately, this barrier presents an obstacle for clean cutting close to objects located in the lawn. Walls, fences, and flower bed borders are some of the typical obstacles that the user needs to navigate the lawnmower around while cutting the grass. A mower typically does not get close enough to these items because lawnmower deck prevents the cutting blades from getting close enough to the obstacles to obtain the desired result. The areas around all of these obstacles in a lawn must be separately addressed by the user once the open area of the lawn has been mowed.

Therefore, a need exists for an article of manufacture for providing a lawnmower trimming and edging extension. The trimming and edging extension is mounted on the outside of the lawnmower deck and includes a rotating string cutter, or similar device, that may cut the grass growing near the lawn obstacles as the user navigates the lawnmower around the rest of the lawn. As such, the present invention attempts to address the limitations and deficiencies of prior solutions utilizing the principles and example embodiments disclosed herein.

### SUMMARY

In accordance with the present invention, the above and other problems are solved by providing an article of manufacture for a lawnmower trimming and edging extension according to the principles and example embodiments disclosed herein

In one embodiment, the present invention is an article of manufacture for providing a lawnmower trimming and edging extension. A lawnmower trimming and edging extension is attached to a lawnmower. The lawnmower has a motor, a deck, and a push handle. The lawnmower extension includes a trimmer motor having a shaft and a self-feeding string trimmer cutter coupled to the shaft. The trimmer motor coupled to the deck and oriented the self-feeding trimmer cutter to cut an area about the deck. The trimming extension controls electrically connects the trimmer motor to an electrical power source and the trimming extension controls. An outside protective plate is coupled to an inside protective plate by a trimmer-edger hinge and to the deck. The trimmer-edger hinge pivots the inside protective plate between a horizontal position and a vertical position. The trimmer motor is coupled to the inside protective plate such that is self-feeding trimmer cutter is oriented as the inside protective plate when it pivots between the horizontal position and the vertical position.

In another aspect of the present disclosure, the electrical power source is a main electrical power source powering an electric lawnmower motor.

In another aspect of the present disclosure, the main power source is a battery.

In another aspect of the present disclosure, the main power source is an AC cord.

In another aspect of the present disclosure, the lawnmower motor is gasoline powered and the electrical power source is a battery.

In another aspect of the present disclosure for gas powered lawnmowers, the generator includes an input shaft coupled to a second pully. The lawnmower motor having a blade shaft coupling a lawnmower cutting blade to the lawnmower motor and a first pulley coupled about the blade shaft and positioned parallel the second pulley, and a connecting belt coupled to the first pulley and the second pulley with rotation of the blade shaft transferred to the input shaft by the connecting belt, first pulley, and second pulley.

In another aspect of the present disclosure, the lawnmower trimming and edging extension is coupled to a front left corner of the lawnmower deck. Of course, the lawnmower trimming and edging extension may also be located on either side, or both sides, of the lawnmower deck, whether residential, commercial, walk-behind, standing or riding lawnmowers.

In another aspect of the present disclosure, the trimmer extension controls are coupled about a top edge of the push handle.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture for a lawnmower trimming and edging extension according to the present invention.

FIG. 2 illustrates another example embodiment of an article of manufacture for a lawnmower trimming and edging extension according to the present invention.

FIGS. 3a-d illustrate various views of the example embodiments of an article of manufacture for a lawnmower trimming and edging extension according to the present invention.

FIG. 4 illustrates an electrical voltage generation subsystem that may be part of one embodiment of the present invention.

### DETAILED DESCRIPTION

This application relates in general to an article of manufacture for providing a lawn care tool, and more specifically, to an article of manufacture for a lawnmower trimming and edging extension according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “worker,” and “user” refer to an entity, e.g. a human, using the lawnmower trimming and edging extension associated with the invention. The term user herein refers to one or more users.

The term “invention” or “present invention” refers to the invention being applied for via the patent application with the title “Lawnmower Extension.” Invention may be used interchangeably with trimmer.

The use of the term lawnmower, while may be described in terms of a residential, walk-behind lawnmower, the present invention may also be part of a riding, standing, or commercial lawnmower, including any possible variation of residential, commercial, walk-behind, standing, or riding lawnmower. The present invention should be defined by the limitations recited in the attached claims, and not by any particular embodiment expressly described herein.

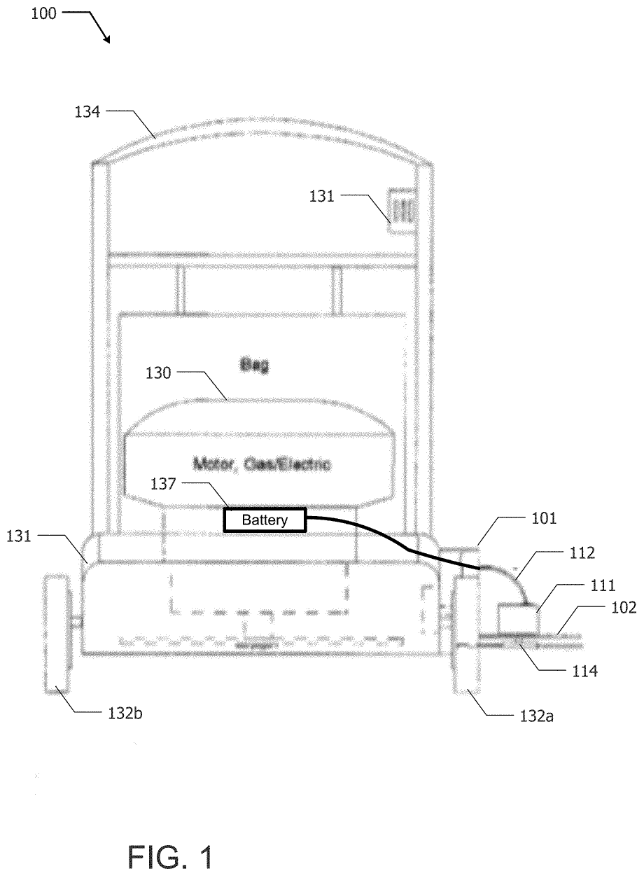

In general, the present disclosure relates to a system and method for providing a lawn care tool. To better understand the present invention, FIG. 1 illustrates an example embodiment of a front view of an article of manufacture for a lawnmower trimming and edging extension. A trimming and edging extension 100 is shown in FIG. 1 attached to a front left corner of a lawnmower 130 and has a trimming string cutter 114 horizontally oriented to cut along the side of a lawnmower 130. The orientation of the trimming string cutter 114 is controlled by changing the orientation of a protective inside plate 102 that is coupled to a protective outside stationary plate 101 using a trimmer-cutter hinge 312. When the protective inside plate 102 is oriented horizontally, the trimming string cutter 114 acts as a trimming device. When the protective inside plate 102 is oriented vertically, the trimming string cutter 114 acts as an edging device. The protective outside stationary plate 101 is attached to a vertical side of the lawnmower deck 131 to position the trimming and edging extension 100 outboard of the lawnmower deck 131 on the left side. In other embodiments not shown, the trimming and edging extension 100 may also be located on the right side and both sides of the lawnmower deck 131 on the same lawnmower 130.

In this embodiment shown in FIG. 1, the trimming and edging extension 100 is attached to the lawnmower deck 131 in front of a left front wheel 132a while being oriented to position a trimming string cutter 114 outside a cutting area beneath the lawnmower deck 131 on its left side. The trimming string cutter 114 is positioned to cut any grass between the lawnmower deck 131 and a lawn obstacle to the left of the lawnmower 130.

The trimming string cutter 114 is positioned to provide a cutting height for the trimming and edging extension 100 that is similar to the cutting blade height of the lawnmower 130. As such, the grass underneath the lawnmower deck 131 may be cut by the cutting blades of the lawnmower 130 and the remaining grass from the edge of the lawnmower deck 131 to the lawn obstacle may be cut by the trimming string cutter 114. The user should not need to return to lawn obstacles for additional trimming once cutting the lawn has been completed.

While the example embodiment of the trimming and edging extension 100 shown in FIG. 1 shows the trimming and edging extension 100 being located along the front left corner of the lawnmower deck 131, the trimming and edging extension 100 may be located along either side of the lawnmower deck 131 along any point on the side and still operate as disclosed herein. The location of the trimming and edging extension 100 on a particular side of the lawnmower deck 131 requires that side of the lawnmower 130 to be directed by the user to be the side that attempts to cut around the lawn obstacles. The location of the trimming and edging extension 100 also may be placed in front of the lawnmower wheels 132a-d, between the lawnmower wheels 132, and behind the lawnmower wheels 132 depending upon how the lawnmower wheels 132 are mounted onto the lawnmower deck 131. In other embodiments not shown, the trimming and edging extension 100 may also be located on the right side and both sides of the lawnmower deck 131 on the same lawnmower 130.

In the embodiment of FIG. 1, the trimming and edging extension 100 is powered by a trimmer motor 111 that causes the trimming string cutter 114 to rotate in a preferred embodiment. The trimmer motor 111 shown is an electrical motor that is powered by a trimmer motor power cable 112 and trimmer motor control cable 138 connected to trimming extension controls 121 and its power source such as a battery. The power source may be a battery 137 located on the lawnmower 130 and connected to the trimmer motor cable 112 and extension controls 121. The power source also may be an electrical plug that is connected to an extension cord. Since the lawnmower 130 itself may be powered by an electric motor or a gasoline-powered engine, the use of a power cord or a battery would be possible.

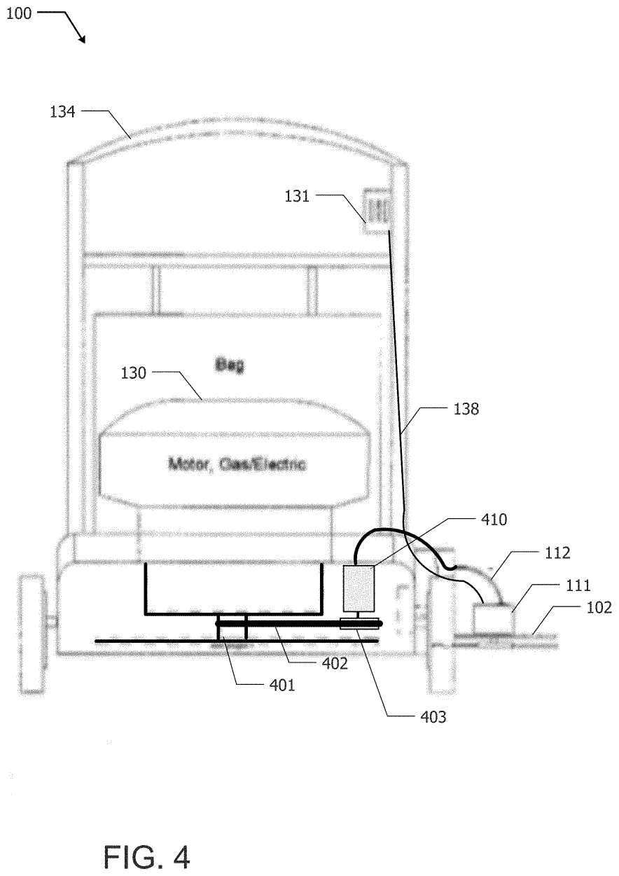

In an alternate embodiment, the trimmer motor 111 may be a mechanical motor that is coupled to a shaft of the engine of the lawnmower 130 such that the rotation of the engine and cutting blades cause the trimming string cutter 114 to rotate as well. Such a connection may utilize a pulley and belt arrangement to transfer the rotation of the engine shaft to the trimming string cutter 114, and by adjusting a ratio of the diameters of the pulley on the engine shaft to the pulley attached to trimming string cutter 114, the rate of rotation of the trimming string cutter 114 may be controlled. A mechanical connection between the engine shaft and trimming string cutter 114 may limit the possible location of the trimming and edging extension 100 along a side of the lawnmower deck 131 as the rotating belt that connects the engine shaft to the trimming string cutter 114 would need to pass through the lawnmower deck 131 at the location of the trimming and edging extension 100 while not being blocked by one of the lawnmower wheels 132. This alternate embodiment is as effective as the electrical trimmer motor 111 shown in FIG. 1 while not requiring an extension cord or a battery. This embodiment, however, is not as readily added to existing lawnmowers as an electrical trimming motor 111 as the mechanical connections are required to pass through the lawnmower deck 131. Addition of an electrical motor to a gas powered lawnmower along with a generator are disclosed in detail below in reference to FIG. 4.

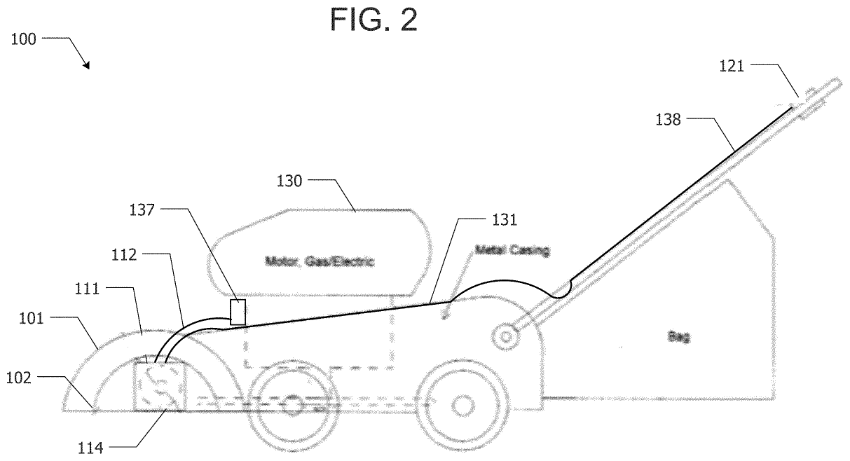

FIG. 2 illustrates another example embodiment of a side view of an article of manufacture for a lawnmower trimming and edging extension according to the present invention. A trimming and edging extension 100 is shown in FIG. 2 also attached to a front left corner of a lawnmower 130 and has a trimming string cutter 114 vertically oriented to cut along the side of a lawnmower 130. In this embodiment, the trimming and edging extension 100 is attached in front of a left front lawnmower wheel 132a while being oriented to have the trimming string cutter 114 cut a line parallel to the path of the lawnmower deck 131 on its left side. The protective inside plate 102 is oriented vertically using the trimmer-cutter hinge 312 that causes the trimming string cutter 114 to also pivot into a vertical position. The cutting strings 301a-b cut a vertical path as they rotate causing grass that extends over an edge of a covered surface to be cut and easily removed. In all other respects the trimming string cutter 114 operates the same way it operates as shown in FIG. 1.

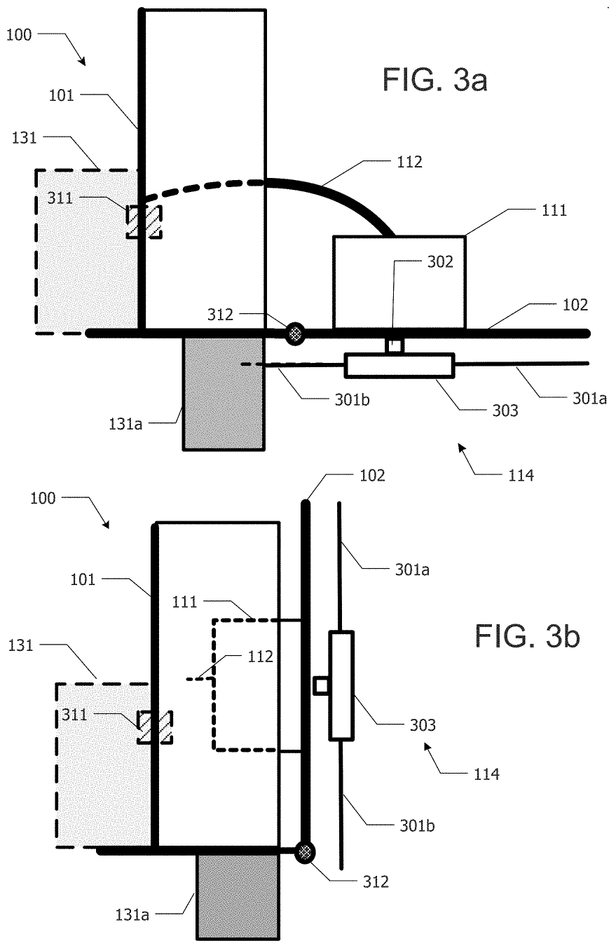

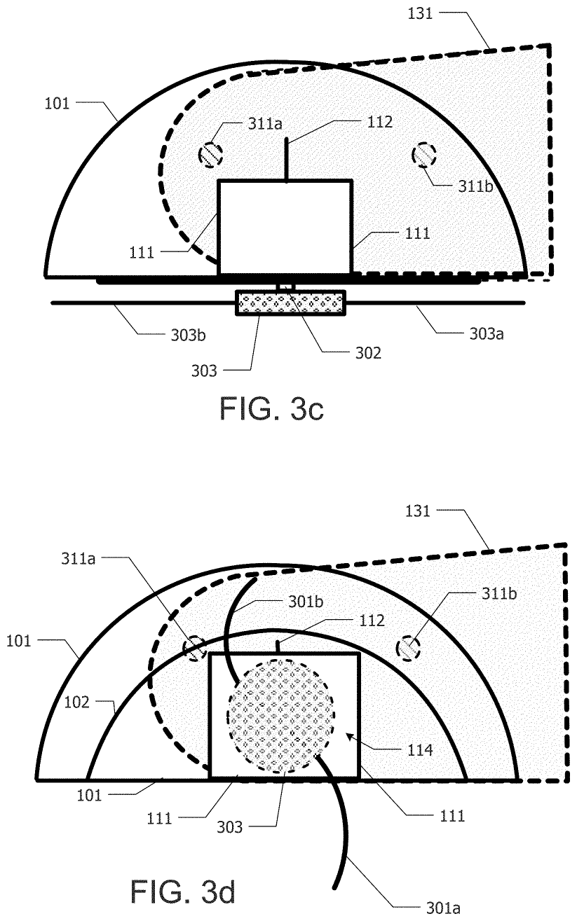

FIGS. 3a-d illustrate various views of the example embodiments of an article of manufacture for a lawnmower trimming and edging extension according to the present invention. FIG. 3a shows an example embodiment of a front view of the trimming and edging extension 100 with the trimming string cutter 114 oriented in a horizontal trimming orientation. FIG. 3b shows an example embodiment of a front view of the trimming and edging extension 100 with the trimming string cutter 114 oriented in a vertical edging orientation. FIG. 3c shows an example embodiment of a side view of the trimming and edging extension 100 with the trimming string cutter 114 oriented in a horizontal trimming orientation. FIG. 3d shows an example embodiment of a front view of the trimming and edging extension 100 with the trimming string cutter 114 oriented in a vertical edging orientation.

The trimming and edging extension 100 acts as a trimming device when the trimming string cutter 114 is oriented horizontally as shown in FIG. 3a and FIG. 3c. As noted briefly above, the trimming string cutter 114 trims the grass along the side of the lawnmower deck 131 that the trimming and edging extension 100 is located. The trimming and edging extension 100 acts as an edging device when the trimming string cutter 114 is oriented vertically as shown in FIG. 3b and FIG. 3d. The trimming string cutter 114 as an edging device cuts the grass vertically perpendicular to the side of the lawnmower deck 131 where the trimming and edging extension 100 is located. Use of the trimming string cutter 114 as an edging device permits the user to cut along edges of covered surfaces such as driveways, sidewalks, and patios to prevent the grass from growing over the covered surfaces.

FIG. 3a shows the protective outside stationary plate 101 connected to the protective inside plate 102 by the trimmer-cutter hinge 312. The protective inside plate 102 pivots when the trimmer-cutter hinge 312 rotates between the two positions. The protective outside stationary plate 101 is attached to the lawnmower deck 131 using one or more attachment devices 311. The attachment devices 311 typically may be a nut and bolt pair that holds the protective outside stationary plate 101 in place against the lawnmower deck 131. FIGS. 3c-d show a pair of attachment devices 311a-b located horizontally along the lawnmower deck 131. Other attachment devices 311 such as rivets and mechanical couplings may be used to hold the protective outside stationary plate 101 together with the lawnmower deck 131. The number of attachment devices 311 used to attach the trimming and edging extension 100 to the lawnmower 130 may vary as needed to hold it securely in place, Additionally, washers, spacers, and related hardware may be used as part of the attachment devices 311 to keep the trimming and edging extension 100 in place.

The electric trimmer motor 111 is shown in FIG. 3a having the trimmer motor cable 112 run to the protective outside stationary plate 101 while the protective inside plate 102 is oriented horizontally. The trimmer motor cable 112 is routed along the lawnmower deck 131 and up the lawnmower handle 134 to connect to the extension controls 121 and power source. A trimmer motor shaft 302 extends outward from the trimmer motor 111 and through the protective inside plate 102 to connect to a string cutting head 303. The string cutting head 303 holds the cutting strings 301 so that they may rotate about the string cutting head 303 when the trimmer motor 111 causes the motor shaft 302, and thus the string cutting head 303, to spin. The direction of the spin of the string cutting head 303 may be in the same or opposite direction as the lawnmower 130 blade. In one embodiment the string cutting head 303 may comprise a self-feeding string spool and case that extends the cutting strings 301 automatically as the cutting strings 301 are worn down from use. Other mechanisms to extend the length of the cutting strings 301 known to be part of electric trimmer may be utilized herein.

The electric trimmer motor 111 is shown in FIG. 3b having the trimmer motor cable 112 run away from the trimmer motor 111 toward the protective outside stationary plate 101 while the protective inside plate 102 is oriented vertically. The trimmer motor 111 is rotated onto a side with the motor shaft 302 and runs horizontally to the motor shaft 302. The pair of cutting strings 301a-b extend upward and downward as the string cutting head 303 rotates about the motor shaft 302.

The electric trimmer motor 111 is shown in a side view in FIG. 3c having the trimmer motor cable 112 run to the protective outside stationary plate 101 while the protective inside plate 102 is oriented horizontally. As above, the trimmer motor shaft 302 extends downward from the trimmer motor 111 and through the protective inside plate 102 to connect to a string cutting head 303. The string cutting head 303 holds the cutting strings 301 so that they may rotate about the string cutting head 303 when the trimmer motor 111 causes the motor shaft 302, and thus the string cutting head 303, to spin.

The side view of both FIGS. 3c-d show a pair of attachment devices 311 coupling the protective outside stationary plate 101 to the lawnmower deck 131. In FIG. 3c, the string cutting head 303 and its pair of cutting strings 301 are positioned to rotate near or below a lower edge of the lawnmower deck 131. The trimmer motor 111 is located on the protective inside plate 102 such that the string cutting head 303 and its pair of cutting strings 301 are centered a known distance from the protective outside stationary plate 101. The string cutting head 303 typically spools out the pair of cutting strings 301 a sufficient length that the rotation of the string cutting head 303 cuts all of the grass up to the edge of the lawnmower deck 131.

In FIG. 3d, the protective inside plate 102 has been oriented upward by the trimmer-cutter hinge 312 such that the string cutting head 303 and its pair of cutting strings 301 are positioned to rotate vertically a known distance from the vertical edge of the lawnmower deck 131. As above, the trimmer motor 111 is located on the protective inside plate 102 such that the string cutting head 303 and its pair of cutting strings 301 are centered a known distance from the protective outside stationary plate 101. The string cutting head 303 typically spools out the pair of cutting strings 301 a sufficient length that the rotation of the string cutting head 303 cuts all of the grass to or below the ground.

FIG. 4 illustrates an electrical voltage generation subsystem that may be part of one embodiment of the present invention. In the embodiment of FIG. 4, an electrically powered trimmer motor 111 is added to the lawnmower 130 as disclosed above. Unlike an electric lawnmower in which the trimmer motor 111 may be powered using the same power source as the lawnmower motor 135, a gas powered lawnmower 130 must have an electrical power source added along with the trimmer motor 111. Of course, a battery may be added and attached to the lawnmower 130 in a convenient location that permits the battery to be easily recharged or to be easily removed for external charging. A removable battery subsystem such as ones typically used in many cordless lower tools may be utilized as part of the present invention.

Alternatively, a small electrical generator 410, such as a magneto or alternator, may be added to generate an electrical voltage for powering the trimmer motor 111 using power cord 112. Such an electrical generator 410 may be powered by rotating its input shaft 404. As is typically done in automobile engines, for example, an alternator is attached to the rotating shaft of the engine by a connecting belt. Such an arrangement is shown in FIG. 4.

A first pulley 401 is added to the shaft 136 connecting the lawnmower blade 137 to the engine 135. A second pulley is coupled to the input shaft 404 to the generator 410. The two pulleys are arranged in a parallel arrangement just above the lawnmower blade 137. A connecting belt 402 is arranged about the two pulleys connecting the action of the rotating shafts to rotate when the lawnmower engine 135 is running. A power cord 112 connects the generator 410 to the trimmer motor 111 and the controls 131 via the control cable 138 allowing the trimmer to operate.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a lawnmower trimming and edging extension to a lawnmower, the lawnmower having a lawnmower motor, a lawnmower deck, and a push handle, the lawnmower trimming and edging extension comprises:
a trimmer motor having a shaft and a self-feeding string trimmer cutter coupled to the shaft, the trimmer motor being coupled to an outside edge of a lawnmower deck and oriented the self-feeding trimmer cutter to cut and edge an area about one side of the lawnmower deck;
trimming extension controls electrically connected to the trimmer motor for activating the operation of the trimmer motor; and
an electrical power source connecting the trimmer motor and the trimming extension controls.

2. The lawnmower trimming and edging extension according to claim 1, wherein the lawnmower trimming and edging extension further comprises:
an outside protective plate couple to an inside protective plate by a trimmer-edger hinge, the trimmer-edger hinge pivots the inside protective plate between a horizontal position and a vertical position;
wherein the trimmer motor being coupled to the inside protective plate having the self-feeding trimmer cutter positioned outward of the inside protective plate such that is self-feeding trimmer cutter is oriented in the same orientation as the inside protective plate as it pivots between the horizontal position and the vertical position.

3. The lawnmower trimming and edging extension according to claim 1, wherein the electrical power source is a main electrical power source powering an electric lawnmower motor.

4. The lawnmower trimming and edging extension according to claim 3, wherein the main power source is a battery.

5. The lawnmower trimming and edging extension according to claim 3, wherein the main power source is an AC cord.

6. The lawnmower trimming and edging extension according to claim 2, wherein the lawnmower motor is gasoline powered and the electrical power source is a battery.

7. The lawnmower trimming and edging extension according to claim 2, wherein the lawnmower motor is gasoline powered and the electrical power source is a generator coupled to the lawnmower motor.

8. The lawnmower trimming and edging extension according to claim 7, wherein the generator having an input shaft coupled to a second pully;
the lawnmower motor having a blade shaft coupling a lawnmower cutting blade to the lawnmower motor and a first pulley coupled about the blade shaft and positioned parallel the second pulley; and
a connecting belt coupled to the first pulley and the second pulley with rotation of the blade shaft transferred to the input shaft by the connecting belt, first pulley, and second pulley.

9. The lawnmower trimming and edging extension according to claim 2, wherein the lawnmower trimming and edging extension is coupled to a front left corner of the lawnmower deck.

10. The lawnmower trimming and edging extension according to claim 2, wherein the trimmer extension controls are coupled about a top edge of the push handle.

11. The lawnmower trimming and edging extension according to claim 2, wherein the lawnmower trimming and edging extension is coupled to a front right corner of the lawnmower deck.

12. The lawnmower trimming and edging extension according to claim 2, wherein the lawnmower trimming and edging extension is coupled to a front left corner and to a front left corner of the lawnmower deck.
